(19) United States
(12) Patent Application Publication
(10) Pub. No.: US 2017/0341265 A1
(43) Pub. Date: Nov. 30, 2017

(54) METHOD AND APPARATUS FOR MANUFACTURING COUNTERTOP

(71) Applicant: Hee Chang KANG, Chungwon (KR)

(72) Inventor: Hee Chang KANG, Chungwon (KR)

(21) Appl. No.: 15/165,596

(22) Filed: May 26, 2016

(30) Foreign Application Priority Data
Feb. 22, 2016 (KR) 10-2016-0020338

(51) Int. Cl. B28D 7/04; A47B 13/08; B28D 1/04; B28D 1/14

(52) U.S. Cl. CPC B28D 7/046; B28D 1/14; A47B 13/08; B28D 1/043

(57) ABSTRACT

The present disclosure provides a method for manufacturing a countertop, where a countertop workpiece may be easily secured to a workpiece-mounting device during the machining thereof, leading to good precision and standardization. This may be achieved using a suction of the countertop workpiece via air intake in the mounting device. Further, the present disclosure provides a countertop machining apparatus including a vacuum chamber divided into a multiple of vacuum sub-chambers disposed in a work table, and a suction panel disposed on the chamber. In this configuration, a number of the vacuum sub-chambers to be kept in a vacuum state may be adjusted. This may lead to a reduction of a power consumption required to suction the countertop workpieces.

### CROSS-REFERENCE TO RELATED APPLICATION

This application claims the benefit of Korean patent application No. 10-2016-0020338 filed on, Feb. 22, 2016, the entire contents of which are incorporated herein by reference for all purposes as if fully set forth herein.

### BACKGROUND

### Field of the Present Disclosure

The present disclosure relates to a method and apparatus for machining a countertop workpiece. Further, the present disclosure relates to a countertop manufactured using the method and apparatus.

### Discussion of the Related Art

One example of a countertop is a sink top plate. Generally, a sink is manufactured to have a dimension based on house specifications. The sink has drawers to receive therein kitchenware, a cleaning unit for cleaning dishes, and a cooking space for cooking foods.

Conventionally, the countertop, for example, the sink top plate is made of a stainless steel, a pure synthetic resin, or a stainless material. However, the countertop made of such materials may exhibit a poor aesthetic sense to a user, may have an easily-bendable or deformable top plate, and may be not manufactured in a mass production.

For those reasons, a countertop made of an artificial marble has been suggested. Generally, a process for manufacturing a sink top plate using the artificial marble may include preparing artificial marble countertop workpiece, cutting predetermined portions of the countertop workpiece, polishing the resulting plate, applying an adhesive to the cut portions of the plate, and boding the cut portions having the adhesive applied thereto.

Conventionally, the cutting and polishing of the artificial marble plate may involve a human worker machining the artificial marble plate using a cutter with a cutting blade and a grinder with a grinding blade held by the worker's hand manually.

This manual machining may lead to a dangerous situation to the worker and, thus, damages to him/her. Further, dusts created from the machining may harm the worker's health. Furthermore, the machining time may be long and thus may be poor at a mass production. Also, the machining may be poor at precision and standardization.

To solve the above problems, the applicant disclosed Korean patent number 10-1017892. However, although an approach disclosed in this patent provides an automatic cutting of a countertop workpiece, the approach may be poor at securing the countertop workpiece during the machining thereof, and, thus, at the precision and standardization.

This “Background” section is provided for background information only. The statements in this “Background” section are not an admission that the subject matter disclosed in this “Background” section constitutes prior art to the present disclosure, and no part of this “Background” section may be used as an admission that any part of this application, including this “Background” section constitutes prior art to the present disclosure.

### SUMMARY

From considerations of the above problems, the present disclosure provides a method for manufacturing a countertop, for example, a sink top plate, where a countertop workpiece may be easily secured to a workpiece-mounting device during the machining thereof, leading to good precision and standardization, and the machining time may be shorter, leading to a mass production.

Further, the present disclosure provides a countertop machining apparatus including a vacuum chamber divided into a multiple of vacuum sub-chambers disposed in a work table, and a suction panel disposed on the chamber. During an operation of the apparatus, only vacuum sub-chambers are kept in a vacuum state on which countertop workpieces are disposed, while remaining vacuum sub-chambers are not kept in a vacuum state on which the countertop workpieces are not disposed. This may be enabled via valves being closed respectively for air intake tubes fluid-coupled to the remaining vacuum sub-chambers. Thus, a number of the vacuum sub-chambers to be kept in a vacuum state may be adjusted. This may lead to a reduction of a power consumption required to suction the countertop workpieces.

One aspect of the present disclosure provides a method for manufacturing a countertop, the method comprising: providing a countertop workpiece; providing a workpiece-mounting device, the device including a pump for air intake; a vacuum plate having a first through-hole defined therein, the first hole being coupled to the pump and acting as an air flow channel during activation of the pump; and a first work plate disposed on the vacuum plate, and having a multiple of second through-holes defined therein; mounting the countertop workpiece on the first work plate of the workpiece-mounting device; blocking non-screened holes of the second through-holes using a blocker, wherein the non-screened holes are not screened by the mounted the countertop workpiece; activating the pump to intake air via the first through-hole and the second through-hole to allow suction of the countertop workpiece to the workpiece-mounting device; and cutting a top portion of the countertop workpiece suctioned to the workpiece-mounting device.

In one embodiment, the method further comprises providing the vacuum plate'having a multiple of air intake grooves defined in a top portion thereof, and the multiple of the air intake grooves extending in mutually-orthogonal directions; and activating the pump such that the multiple of the air intake grooves receive air intaked from the first through-hole to allow suction of the first work plate to the vacuum plate.

One aspect of the present disclosure provides a method for manufacturing a countertop, the method comprising: providing a countertop workpiece; providing a workpiece-mounting device, the device including a pump for air intake; a vacuum plate having a first through-hole defined therein, the first hole being coupled to the pump and acting as an air flow channel during activation of the pump; and a first work plate disposed on the vacuum plate, and having a multiple of second through-holes defined therein; a second work plate disposed on the first work plate, and a hollow mount having one open end and the other end disposed on the second work plate, the mount having a third through-hole defined in a side wall thereof, the third hole being coupled to the pump and acting as an air flow channel during activation of the pump, mounting the countertop workpiece on the open end of the mount of the workpiece-mounting device; activating the pump to intake air via the first through-hole and the second through-hole to allow suction of the first and second work plates to the vacuum plate, and to intake air via the third hole to allow suction of the countertop workpiece to the mount; and drilling the countertop-workpiece using a machining apparatus.

One aspect of the present disclosure provides a countertop machining apparatus for vacuum-suctioning a countertop workpiece thereto and cutting the countertop workpiece using a cutter, the apparatus comprising: a work table having a vacuum groove defined in a top portion thereof; a suction panel disposed on the work table to block the vacuum groove, the panel having a multiple of through-holes formed therein; a vacuum pump configured to intake air in the vacuum groove; and a vacuum chamber disposed in the vacuum, groove, the chamber being defined into a multiple of vacuum sub-chambers, each sub-chamber having an open top portion, wherein the vacuum pump is configured to intake air in each of the vacuum sub-chambers.

In one embodiment, a plurality of sealing frames are disposed on the suction panel to correspond to the vacuum sub-chambers respectively, wherein the through-holes are located within each of the sealing frames, wherein a top portion of the suction panel is divided in a corresponding manner with the vacuum sub-chambers.

In one embodiment, an inner plane area of each of the vacuum sub-chambers is equal to or smaller than an inner plane area of each of the sealing frames.

In one embodiment, each vacuum sensor is disposed in each of the vacuum sub-chambers, wherein each sensor is configured to detect a corresponding sub-chamber in a non-vacuum state and to inform a controller of the detected sub-chamber.

In one embodiment, each air intake tube is fluid-coupled to each sub-chamber, wherein each valve is disposed to each air intake tube, wherein the controller is configured to receive the detected sub-chamber and to close the valve corresponding to the air intake tube correspond to the detected sub-chamber.

One aspect of the present disclosure provides a stone-based countertop workpiece comprising: a rectangular workpiece body having longitudinal and transverse sides, first longitudinal and transverse stripes coupled to the body, the first longitudinal and transverse stripes being substantially right angled relative to the body, wherein the first longitudinal and transverse stripes are monolithic with the body.

In one embodiment, the workpiece further comprises second longitudinal and transverse stripes coupled to the first longitudinal and transverse stripes respectively, wherein the second longitudinal and transverse stripes are substantially right angled relative to the first longitudinal and transverse stripes respectively, wherein the first and second longitudinal and transverse stripes are monolithic with the body.

In one embodiment, the first longitudinal and transverse stripes have substantially the same thickness, wherein the second longitudinal and transverse stripes have substantially the same thickness.

In accordance with the present disclosure, the countertop workpiece may be firmly secured to the workpiece-mounting device to allow precise machining of the countertop workpiece. This firm securing may be simply realized by the vacuum pump intaking air in the workpiece-mounting device on which the countertop workpiece is mounted. Further, the firm securing of the countertop workpiece may allow machining thereto based on various designs and desires of the worker.

Further, in accordance with the present disclosure, the slightly-bent countertop workpiece may be brought into a completely evenly flat state via the vacuum pump intaking air in the workpiece-mounting device.. This may lead to more reliable machining and thus a high yield and, thus a mass production of a countertop.

Furthermore, in accordance with the present disclosure, during an operation of the countertop machining apparatus, only vacuum sub-chambers are kept in a vacuum state on which countertop workpieces are disposed, while remaining vacuum sub-chambers are not kept in a vacuum state on which the countertop workpieces are not disposed. This may be enabled via valves being closed respectively for air intake tubes fluid-coupled to the remaining vacuum sub-chambers. Thus, a number of the vacuum sub-chambers to be kept in a vacuum state may be adjusted. This may lead to a reduction of a power consumption required to suction the countertop workpieces.

### BRIEF DESCRIPTION OF THE DRAWINGS

A brief description of each drawing is provided to more fully understand the drawings, which is incorporated in the detailed description of the disclosure.

FIG. 1 illustrates a perspective view of a machining apparatus used in a method for machining a countertop workpiece in accordance with one embodiment of the present disclosure.

FIG. 2 illustrates a side view of a state when a countertop workpiece is mounted on a first work plate, in accordance with one embodiment of the present disclosure.

FIG. 3 illustrates a top view of a vacuum plate in accordance with one embodiment of the present disclosure.

FIG. 4 illustrates a top view of a first work plate in accordance with one embodiment of the present disclosure.

FIG. 5 illustrates a side view of a state when a countertop workpiece is mounted on a hollow mount, in accordance with one embodiment of the present disclosure.

FIG. 6 illustrates a perspective view of hollow mount in accordance with one embodiment of the present disclosure.

FIG. 7 illustrates a flow chart of a method for machining a countertop workpiece in accordance with one embodiment of the present disclosure.

FIG. 8 illustrates a flow chart a method for machining a countertop workpiece in accordance with another embodiment of the present disclosure.

FIG. 9A to FIG. 9C illustrate respective perspective views of a countertop workpiece having an inner stripe and an outer stripe formed respectively in four peripheral regions thereof using a countertop machining apparatus in accordance with the present disclosure.

FIG. 10 illustrates a perspective view of a right side portion of the countertop workpiece having inner and outer stripes formed therein.

FIG. 11 illustrates a perspective view of a finished countertop workpiece having folded portions at inner stripe and outer stripes.

FIG. 12 illustrates a schematic view of a countertop machining apparatus in accordance with another embodiment of the present disclosure.

FIG. 13 illustrates a schematic view of a chamber configuration of a countertop machining apparatus in accordance with another embodiment of the present disclosure.

FIG. 14 illustrates a schematic view of a suction panel of a countertop machining apparatus in accordance with another embodiment of the present disclosure.

FIG. 15 illustrates a schematic view of an operation state of a countertop machining apparatus in accordance with another embodiment of the present disclosure.

FIG. 16 illustrates a block diagram describing a countertop machining apparatus in accordance with another embodiment of the present disclosure.

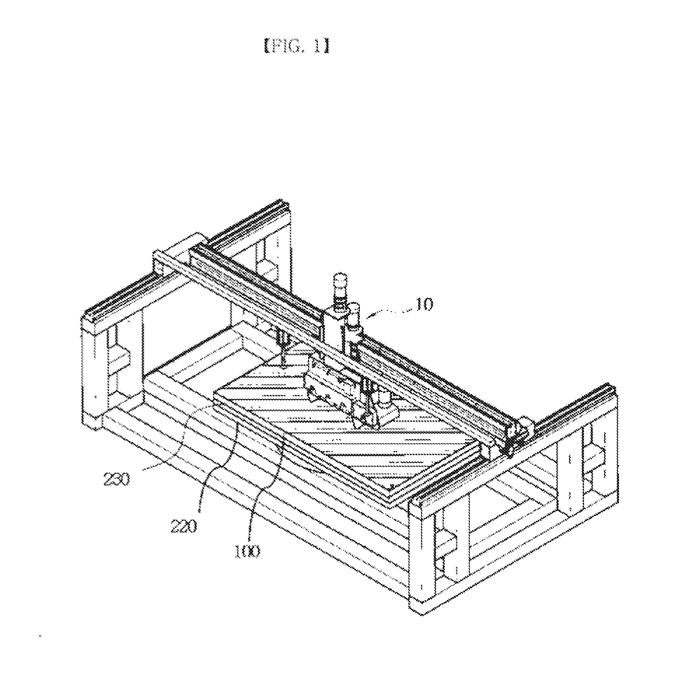

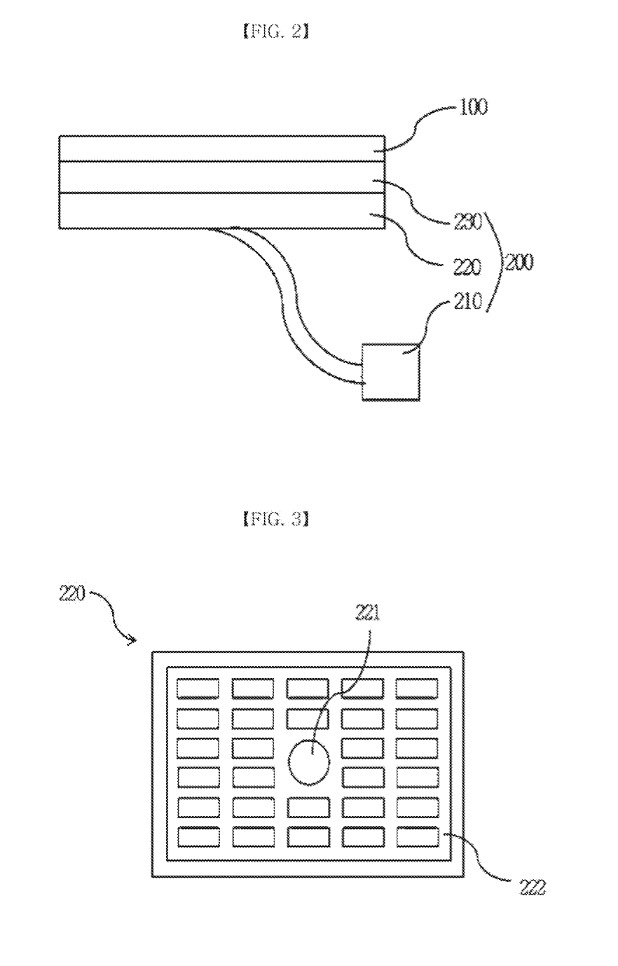

### DETAILED DESCRIPTIONS

Examples of various embodiments are illustrated in the accompanying drawings and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present,

The terminology used herein is for the purpose of describing particular embodiments only and is, not intended to be limiting of the present disclosure, As used herein, the singular forms “a” and an are intended to include the plural forms as well, unless the context dearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list,

Spatially relative terms, such as “beneath,” “below,” “lower” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure,

As used herein, the term “substantially,” “about,” and similar terns are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

Hereinafter, a method for manufacturing a countertop in accordance with the present disclosure will be described in details with reference to attached drawings.

One aspect of the present disclosure is directed to a cutting of a countertop workpiece 100. This aspect provides a method for manufacturing a countertop comprising: providing a countertop workpiece 100; providing a workpiece-mounting device 200, wherein the workpiece-mounting device 200 includes a pump 210 for air intake, a vacuum plate 220 having a first through-hole 221 defined therein, the first hole 221 being coupled to the pump 210 and acting as an air flow channel during activation of the pump 210, and the first work plate 230 disposed on the, vacuum plate 220, and having a multiple of second through-holes 231 defined therein; mounting the countertop workpiece 100 on the first work plate 230 of the workpiece-mounting device 200; blocking non-screened holes of the second through-holes 231 using a blocker 300, wherein the non-screened holes are not screened by the mounted the countertop workpiece 100, activating the pump 210 to intake air via the first through-hole 221 and the second through-hole 231 to allow suction of the countertop workpiece 100 to the workpiece-mounting device 200; and cutting a top portion of the countertop workpiece 100 suctioned to the workpiece-mounting device 200.

Using the method for manufacturing the countertop in accordance with the present disclosure, the countertop workpiece may be easily secured to the workpiece-mounting device during the machining thereof, leading to good precision and standardization, and the machining time may be shorter, leading to a mass production.

Specifically in the present disclosure, during the machining of the countertop workpiece, the countertop workpiece may be advantageously secured firmly to the workpiece-mounting device, leading to the good precision and standardization. For this, the countertop workpiece is mounted on the workpiece-mounting device to suction the countertop workpiece via air intake using the vacuum pump to firmly secure countertop workpiece thereto. In this way, the countertop workpiece may be precisely machined based on a variety of patterns and the desired designs. Further, in the present disclosure, the workpiece-mounting device may suction and pressure strongly and uniformly the slightly-bent countertop workpiece via air intake using the vacuum pump to bring the countertop workpiece into be in a substantially evenly flat state. This may lead to a stable machining process, and to a high yield, and, thus, a mass production of the countertop.

The countertop workpiece may be made of a natural stone or artificial marble. The artificial marble may be made of about 90% stone and about 10% synthetic resin. The present disclosure is not limited thereto. The mixture ratio between the stone and resin may vary depending on applications of the countertop. The “90% stone” may be formed by a mixture of fractured pieces of a natural stone and a cement, and may be employed, for example, as an office floor. A “100% stone” may refer to a natural stone and may be classified into a marble and a granite. Generally, the 100% stone may be made of fractured pieces of the granite.

First, the countertop workpiece 100 to be formed into a countertop is prepared. The countertop workpiece 100 may have a variety of configurations depending on applications of the sink.

Then, the countertop workpiece 100 is mounted on the workpiece-mounting device 200, for example, for a subsequent “V” shaped cutting of a top portion of the countertop workpiece 100. Specifically, the countertop workpiece 100 is mounted on the first work plate 230 of the workpiece-mounting device 200, wherein the workpiece-mounting device 200 includes the pump 210 for air intake, the vacuum plate 220 having the first through-hole 221 defined therein, the first hole being coupled to the pump 210 and acting as an air flow channel during activation of the pump 210, and the first work plate 230 disposed on the vacuum plate 220, and having a multiple of the second through-hole 231 defined therein.

Regarding the mounting device 200, the pump 210 may act to intake air between the vacuum plate 220 and first work plate 230 to suction first work plate 230 to the vacuum plate 220 and, at the same time, to suction the countertop workpiece 100 to the first work plate 230. The pump 210 may not be limited in a configuration thereof as long as the pump acts to intake air between the vacuum plate 220 and first work plate 230 to suction first work plate 230 to the vacuum plate 220 and to suction the countertop workpiece 100 to the first work plate 230. The vacuum plate 220 may be implemented as a plate-shaped member, and may be coupled to the pump 210 and has the first through-hole 221 defined therein. The first through-hole 221 may act as an air flow channel during the activation of the pump 210. In FIG. 3, the first through-hole 221 is singular. The present disclosure is not limited thereto. The skilled person to the art, may appreciate that a number of the first through-holes 221 may depend on characteristics of the countertop workpiece, and configurations of the workpiece-mounting device. The vacuum plate 220 may have a multiple of air intake grooves 222 defined in a top portion thereof. The multiple of air intake grooves 222 may extend in mutually-perpendicular directions, and, thus, form a matrix shape. During the activation of the pump 210, the air intake grooves 222 may act to receive air intaked from the first through-hole 221 to allow suction <of the first work plate 230 to the vacuum plate 220. The first work plate 230 may be implemented as a plate-shaped member, and have a multiple of second through-holes 231 defined therein. The first work plate 230 is disposed on a top face of the vacuum plate 220. The first work plate 230 may vary in a shape thereof. In one example, when the vacuum plate 220 has a rectangular shape, the first work plate 230 may have a rectangular shape with the same size as that of the vacuum plate 220. During the activation of the pump, the plurality of the second through-hole 231 may receive air from the first through-hole 231 and/or the multiple of air intake grooves 222 to allow suction of the countertop workpiece 100 to the first work plate 230.

Thereafter, non-screened second through-holes 231 by the mounted countertop workpiece 100 may be blocked with the blocker 300. In this connection, during the activation of the pump, in order for the first work plate 230 to be firmly suctioned to the vacuum plate 220, the non-screened second through-holes 231 by the mounted countertop workpiece 100 may be blocked with the blocker 300. The blocker 300 may not be limited in a configuration thereof as long as it may sufficiently block the second through-hole 231. In one example, the blocker 300 may be implemented as an adhesive tape. The blocker 300 may vary in a size thereof depending on applications of the countertop. After mounting the countertop workpiece 100 on the first work plate 230, the non-screened second through-holes 231 by the mounted countertop workpiece 100 may be blocked with the blocker 300. This may lead to machining of the countertop workpiece 100 with various sizes and shapes.

During the activation of the pump 210, the countertop workpiece 100 is secured to the countertop workpiece 100 for a subsequent reliable machining to the workpiece 100. Specifically, the pump 210 is activated to intake air through the first through-hole 221 and second through-holes 231 to allow strong and firm suction of the countertop workpiece 100 to the workpiece-mounting device 200. This strong and firm suction may force the countertop workpiece 100 into a completely evenly flat state on the workpiece-mounting device 200. In other words, the pump 210 is activated to intake air between the vacuum plate 220 and first work plate 230 to allow the suction of the first work plate 230 to the vacuum plate 22, and, at the same time, to intake air through the second through-holes 231 in the first work plate 230 to allow the suction of the countertop workpiece 100 to the first work plate 230. In this way, an easy and strong securing of the countertop workpiece 100 to the workpiece-mounting device may be realized. Further, at this step, the slightly-bent countertop workpiece may be brought into a completely evenly flat state on the workpiece-mounting device 200 via the intaked air using the vacuum pump and, thus, a strong suction and pressure of the countertop workpiece 100 to the workpiece-mounting device 200. This may allow more reliable machining of the countertop workpiece 100 to increase a yield of the countertop, and, thus, to a mass production of the countertop workpiece 100.

Finally, the countertop workpiece 100 secured to the workpiece-mounting device 200 is subjected to a “V” shaped cutting of a top portion thereof using a machining apparatus 10. In this connection, the countertop workpiece 100 may be machined based on desired designs (for example, a “V” groove cutting). The machining apparatus 10 may be not limited in a configuration thereof as long as it is known to the skilled person to the art. In one example, the machining apparatus 10 may be implemented as that as disclosed in Korean Patent Number 10-1017892 assigned to the applicant.

Since the countertop workpiece 100 may be made of a natural or artificial stone with a high strength, the V shaped cutting may undergo a great load. In order to withstand the load, a clamp may be used. However, in this case, the clamp may be insufficient to withstand the load. Thus, the present disclosure may employ a vacuum,

Another aspect of the present disclosure is directed to a drilling for forming holes in the countertop workpiece. This drilling may be conducted after the above top-portion machining thereof. Specifically, this aspect of the present disclosure provides a method for manufacturing a countertop, the method comprising: providing a countertop workpiece 100; providing a workpiece-mounting device 200, the device including a pump 210 for air intake; a vacuum plate 220 having a first through-hole 221 defined therein, the first hole being coupled to the pump and acting as an air flow channel during activation of the pump; and a first work plate 230 disposed on the vacuum plate 220, and having a multiple of second through-holes 231 defined therein; a second work plate 240 disposed on the first work plate 220, and a hollow mount 250 having one open end and the other end disposed on the second work plate 240, the mount 250 having a third through-hole 251 defined in a side wall thereof, the third hole 251 being coupled to the pump and acting as an air flow channel during activation of the pump 210; mounting the countertop workpiece 100 on the open end of the mount 250 of the workpiece-mounting device 200; activating the pump 210 to intake air via the first through-hole 221 and the second through-holes 231 to allow suction of the first and second work plates 230 and 240 to the vacuum plate 220, and, at the same time, to intake air via the third hole 251 to allow suction of the countertop workpiece 100 to the mount 250; and drilling the countertop workpiece 100 using a machining apparatus 10,

First, the countertop workpiece 100 to be formed into a countertop is prepared. The countertop workpiece 100 may have a variety of configurations depending on applications of the sink.

Then, the countertop workpiece 100 is mounted on the workpiece-mounting device 200, for example, for a subsequent drilling of the countertop workpiece 100. Specifically, the countertop workpiece 100 is mounted on the mount 250 of the workpiece-mounting device 200. The device includes a pump 210 for air intake; a vacuum plate 220 having a first through-hole 221 defined therein, the first hole being coupled to the pump and acting as an air flow channel during activation of the pump; and a first work plate 230 disposed on the vacuum plate 220, and having a multiple of second through-holes 231 defined therein; a second work plate 240 disposed on the first work plate 220, and a hollow mount 250 having one open end and the other end disposed on the second work plate 240, the mount 250 having a third through-hole 251 defined in a side wall thereof, the third hole 251 being coupled to the pump and acting as an air flow channel during activation of the pump 210.

The workpiece-mounting device 200 in this aspect may be manufactured using the workpiece-mounting device 200 as employed in the cutting process of the countertop workpiece 100 as described above. Specifically, the activation of the pump 210 may stop in connection to the previous cutting method. Then, the blocker 300 may be removed from the first plate 230. Thereafter, the second work plate 240 is disposed on the first work plate 220. Then, the hollow mount 250 having one open end and the other end disposed on the second work plate 240 is provided. The mount 250 has the third through-hole 251 defined in a side wall thereof, the third hole 251 being coupled to the pump 210 and acting as an air flow channel during activation of the pump 210.

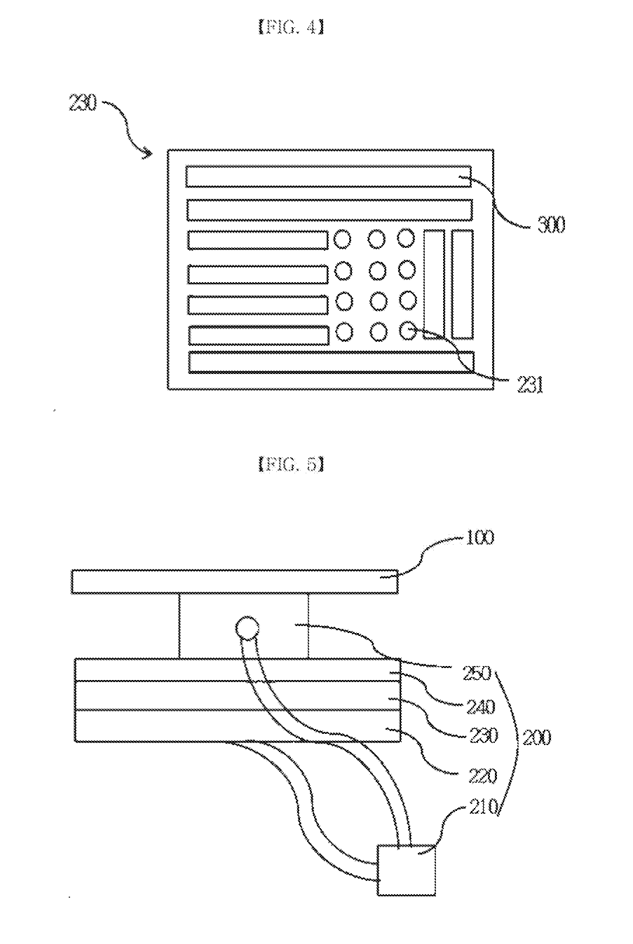

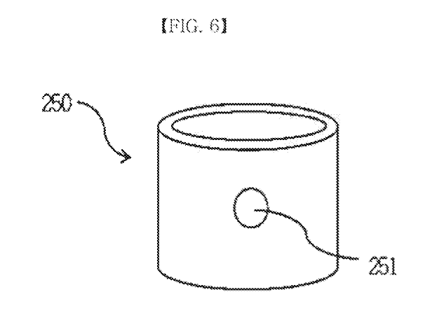

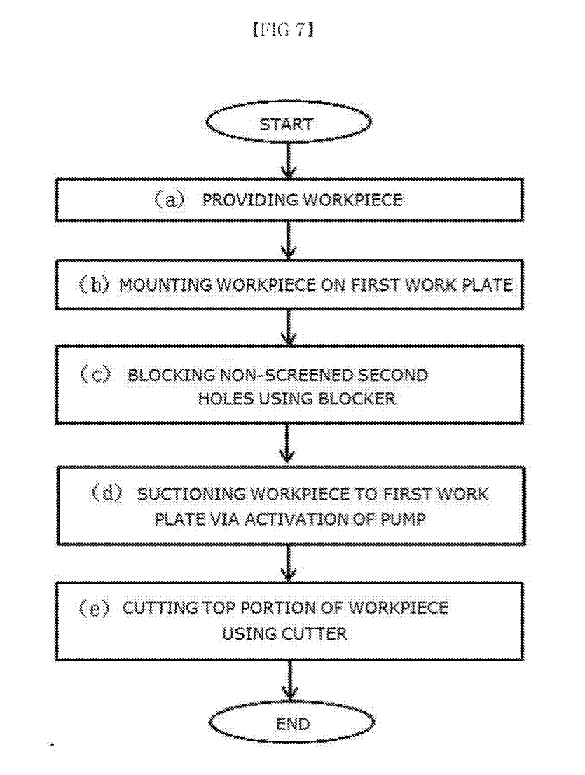

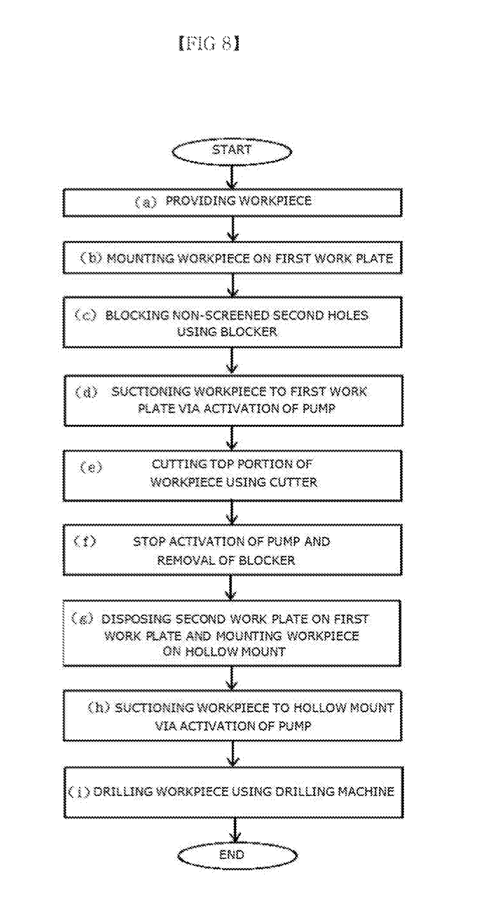

The second work plate 240 may be implemented in a plate-shape member. The second work plate 240 is disposed on the first work plate 230 to block all of the second through-holes 231 defined in the first work plate 230. The hollow mount 250 may be implemented in a tube shape. The hollow mount 250 has the third through-hole 251 defined in a side wail thereof. The third hole 251 is coupled to the pump and act as an air flow channel during the activation of the pump 210. The hollow mount 250 has one open end, and the opposite other end. This other end is disposed on the top face of the second work plate 240. The second work plate 240 may have the same size as that of the first work plate 230 as shown in FIG. 5. However, the present disclosure is not limited thereto. The skilled person to the art may appreciate that a size ratio between the second work plate 240 and the first work plate 230 may vary depending on applications of the countertop workpiece or the countertop. During the activation of the pump 210, the pump intakes air in the hollow mount 250 via the third hole 251 defined in the hollow mount 250, to allow suction of the countertop workpiece 100 to the mount 250, more specifically onto the open end thereof.

Then, the activating of the pump 210 may enable air intake via the first through-hole 221 and the second through-holes 231 to allow suction of the first and second work plates 230 and 240 to the vacuum plate 220, and, at the same time, to intake air via the third hole 251 to allow suction of the countertop workpiece 100 to the mount 250. Specifically, the pump 210 is activated to intake air via the first through-hole 221 to allow suction of the first work plate 230 to the vacuum plate 220, and to intake air via the second through-hole 231 to allow suction of the second work plate 240 to the first work plate 230, and to intake air via the third through-hole 251 to allow suction of the countertop workpiece 100 to the hollow mount 250.

Finally, the countertop workpiece 100 is drilled using the machining apparatus 10. The drilling may be conducted based on desired designs. The machining apparatus 10 may be not limited in a configuration thereof as long as it is known to the skilled person to the art. In one example, the machining apparatus 10 may be implemented as that as disclosed in Korean Patent Number 10-1017892 assigned to the applicant.

Next, a method for machining a countertop workpiece using the machining apparatus 10 in accordance with the present disclosure to form a V shaped groove in the countertop workpiece will be described in details.

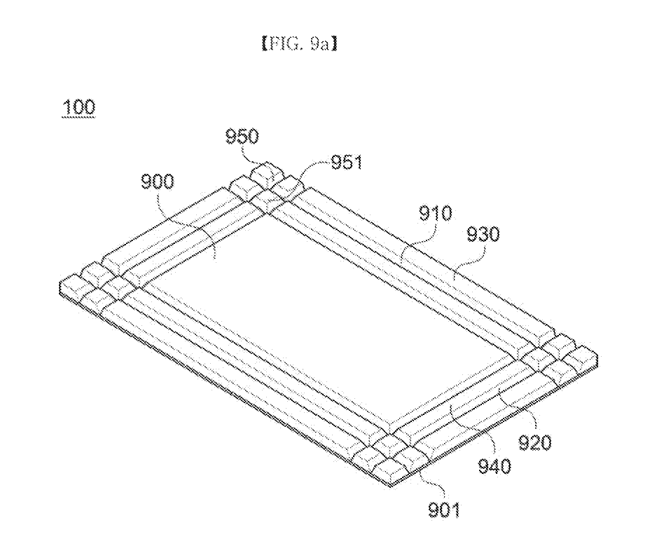

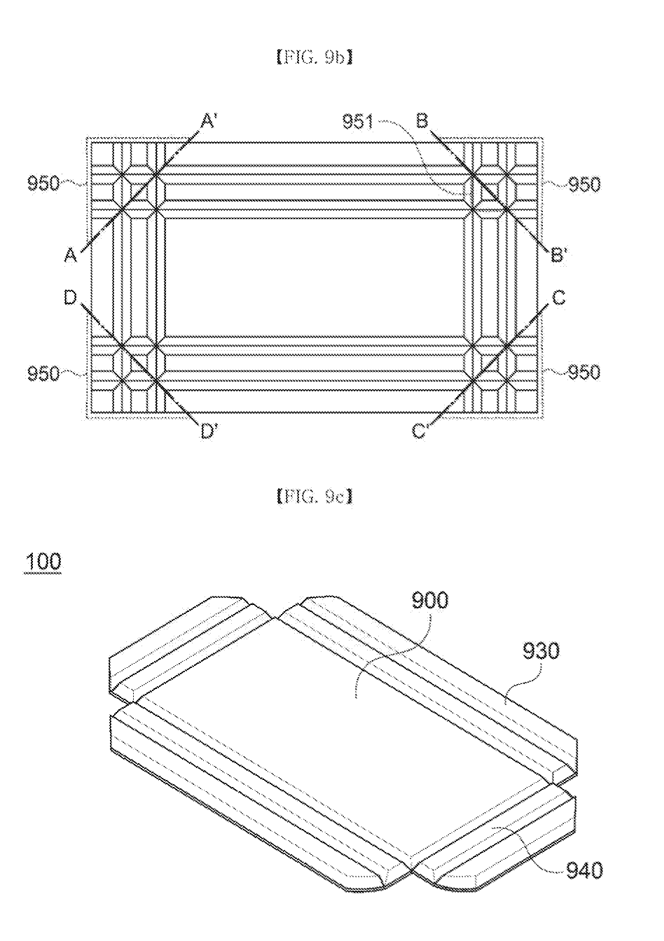

FIG. 9A illustrates a countertop workpiece 100 having a V shaped groove formed at a top portion thereof using a countertop machining apparatus in accordance with the present disclosure. In this connection, the countertop workpiece 100 may be made of a natural stone or artificial marble. In one example, the countertop workpiece 100 may be made of MMA, quartz, or the like.

Specifically, referring to FIG. 9A to FIG. 11, a method for machining a countertop workpiece using a countertop machining apparatus in accordance with the present disclosure to form a V shaped groove in a top portion of the countertop workpiece will be described in details.

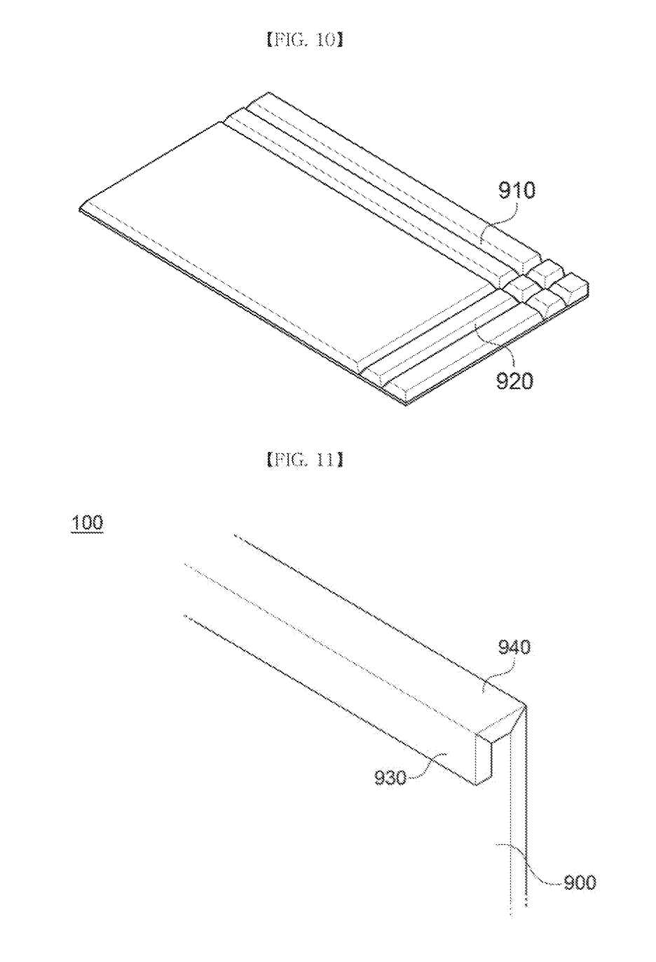

FIG. 9A to FIG. SC illustrate respective perspective views of a countertop workpiece 100 having an inner stripe and an outer stripe formed respectively in four peripheral regions thereof using a countertop machining apparatus in accordance with the present disclosure. FIG. 10 illustrates a perspective view of a right side portion of the countertop workpiece 100 having the inner stripe and outer stripe formed therein. FIG. 11 illustrates a perspective view of a finished countertop workpiece 100 having folded portions at the inner stripe and outer stripe.

First, an adhesive tape 901 is attached to the countertop workpiece 100 at an entire bottom face thereof. In this embodiment, the tape 901 may be implemented as a general tape, silicon, acryl, urethane, or the like. Preferably, a thickness of the tape may be 0.075T. The tape may be made of a material with a good bonding force with a stone, a durable coating film, and with a good bonding maintenance in a touch with water.

Next, the countertop workpiece 100 is mounted on a countertop machining apparatus 10 while the bottom face having the tape 901 thereon faces downwards. Then, a vacuum is applied to the countertop machining apparatus 10 as described above, to secure the countertop workpiece 100 to the machining apparatus 10. Thereafter, a movement of a cutter (not shown) of the countertop machining apparatus 10 may lead to a formation of V shaped grooves with a uniform thickness, and thus, a formation of stripes 930 and 940 in a top portion of the countertop workpiece 100 in the four peripheral regions thereof. Specifically, as shown in FIG. 9A, V shaped grooves 910 and 920 with a uniform thickness are formed in a top portion of the countertop workpiece 100 in the four peripheral regions thereof in mutual-orthogonal directions, and, thus, the stripes 930 and 940 may be formed in a parallel manner to each other. In this embodiment, the two stripes 930 and 940 formed respectively in the four peripheral regions of the countertop workpiece 100 may correspond to the inner stripe and outer stripe respectively. Further, the V shaped grooves 910 and 920 are formed such that a longitudinal stripe 930 and a transverse stripe 940 may have substantially the same width. In this embodiment, in a folded state, the outer stripe may have the same thickness of about 40 mm in the longitudinal and transverse directions, while the longitudinal and transverse inner stripes may have thicknesses of about 30 m and about 15 m respectively. In this way, the outer stripe may have a thickness larger than that of the inner stripe. The present disclosure is not limited thereto. The outer stripe and inner stripe may have substantially the same thickness. In an alternative, the outer stripe may have a thickness smaller than that of the inner stripe.

porn In one embodiment, an appropriate adjustment of the thickness of the tape 901 may allow a continuity of the tape 901 at the formation of the V shaped groove 910, 920 in the countertop workpiece 100, and thus, an non-mobile state of the countertop workpiece body 900 and the stripes 930 and 940 in the four peripheral regions attached to the tape. In this connection, the V shaped grooves 910 and 920 each may have an inner angle of about 80 to 100 degree, more strictly, about 90 degree. The present disclosure is not limited thereto,

Thereafter, as shown in FIG. 9B, the countertop workpiece 100 having the stripe formed therein together with the corresponding tape 901 portion may be partially cut away at four corners 950 thereof along A-A′, B-B′, C-C′, and D-D′ lines respectively. Then, not-yet cut away corner portions 951 having the V shaped groove formed therein are removed away together with the corresponding tape 901 portion. In this way, as shown in FIG. 9C, the countertop workpiece 100 having the outer and inner stripes 930 and 940 in the four peripheral side potions may be obtained.

The body 900 of the resulting countertop workpiece 100 and the inner and outer stripes 930 and 940 in the four peripheral regions thereof respectively have the tape attached to a bottom face thereof, and, thus, do not move relative to each other.

Thereafter, an adhesive material is applied onto a top face of the countertop workpiece at an edge of the body 900 thereof, and edges of the stripes 930 and 940. That is, in the edges, the V shaped grooves 910 and 920 are formed. Thus, the adhesive material is applied to a surface of the V shaped grooves 910 and 920. In this embodiment, the adhesive material employs a MMA-acrylic bond. The present disclosure is not limited thereto. The adhesive material is not limited to a specific one as long as it can sufficiently bond pieces of stones to each other. For example, the adhesive material may include cyanoacrylate, epoxy, or the like.

Thereafter, the inner stripes are folded along the direction of the V shaped grooves 910 and 920 to be bonded to the body 900 of the countertop workpiece 100 via the adhesive material. Thereafter, the outer stripes are folded along the direction of the V shaped grooves 910 and 920 to be bonded respectively to the inner stripes via the adhesive material. In this way, the outer and inner stripes 930 and 940 are folded toward the body 900 of the countertop workpiece. The tape attached to bottom faces of the outer and inner stripes 930, 940 and the body 900 of the resulting countertop workpiece is removed to obtain a finished countertop workpiece 100,

FIG. 10 illustrates only one portion, that is, a right and upper portion of the countertop workpiece 100 with having the grooves formed therein when the workpiece 100 is quadrisected. Depending on applications of the countertop workpiece 100, a countertop workpiece 100 may be employed entirely, may be divided into a certain number of sections. In the latter case, only a portion with a necessary extending direction may be employed.

As described above with reference to FIG. 9A, FIG. 9B and FIG. 10, the V shaped grooves are formed in the peripheral region of the countertop workpiece 100 to form the stripes, which, in turn, are folded to obtain the countertop workpiece 100 as shown in FIG. 11.

As shown in FIG. 11, when each of the V shaped groove has an inner angle of about 90 degree, each inner stripe closer to the body 900 of the countertop workpiece 100 is folded to be substantially right angled to the body 900 of the countertop workpiece 100, and each outer stripe away from the body 900 of the countertop workpiece 100 is folded to be substantially right angled to each inner stripe. Thus, each outer stripe away from the body 900 of the countertop workpiece 100 is folded to be substantially parallel to the body 900 of the countertop workpiece 100. Further, in order to suppress a deformation of the countertop workpiece 100 over time, a reinforce member made of, for example, a plastic, a stone or the like may be disposed between each outer stripe and the body 900 of the countertop workpiece,

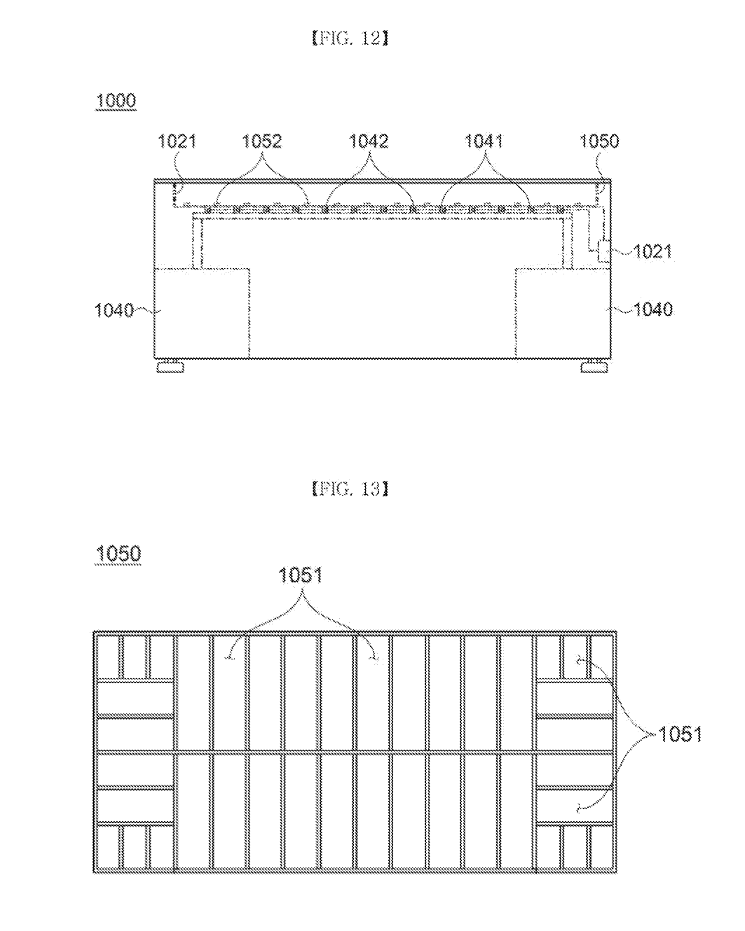

Hereinafter, referring to FIG. 12 to FIG, 16, a countertop machining apparatus 1000 in accordance with another embodiment of the present disclosure will be described,

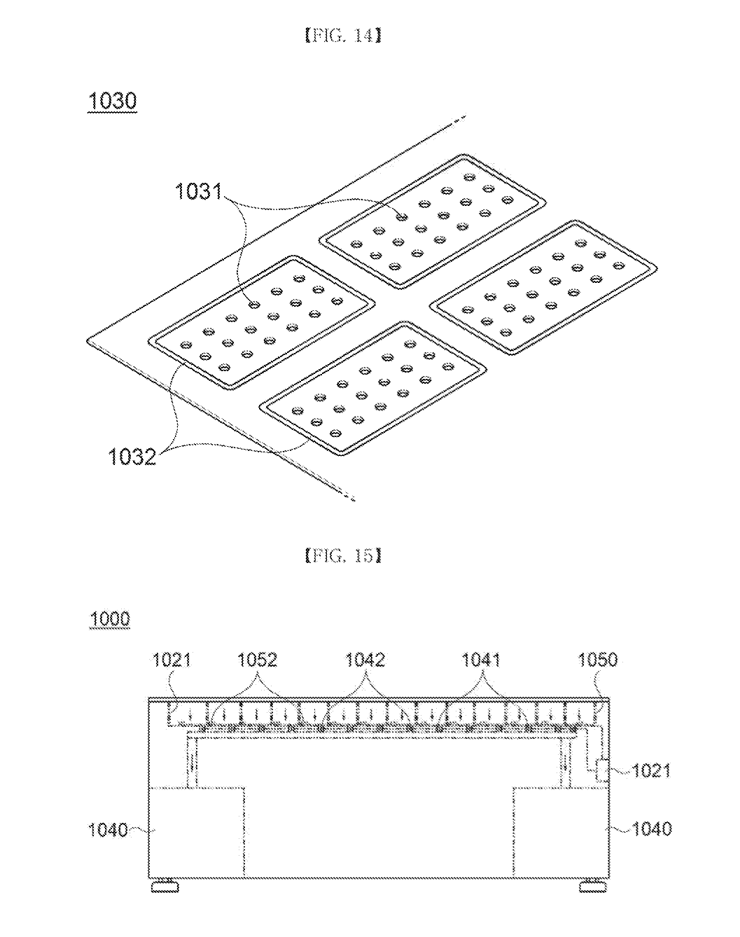

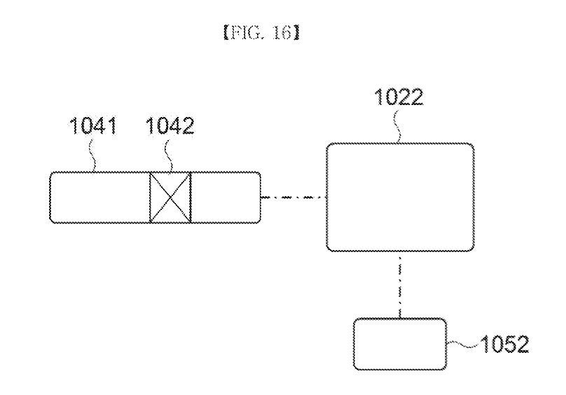

FIG. 12 illustrates a schematic view of a countertop machining apparatus 1000 in accordance with another embodiment of the present disclosure. FIG. 13 illustrates a schematic view of a chamber configuration of a countertop machining apparatus 1000 in accordance with another embodiment of the present disclosure, FIG. 14 illustrates a schematic view of a suction panel of a countertop machining apparatus 1000 in accordance with another embodiment of the present disclosure. FIG. 15 illustrates a schematic view of an operation state of a countertop machining apparatus 1000 in accordance with another embodiment of the present disclosure, FIG. 16 illustrates a block diagram describing a countertop machining apparatus 1000 in accordance with another embodiment of the present disclosure.

The countertop machining apparatus 1000 in accordance with another embodiment of the present disclosure may vacuum-suction a countertop workpiece and cut one face portion thereof using a cutting blade. For this, as shown in the figures, this countertop machining apparatus may include a work table 1020 having a vacuum groove 1021 formed in a top portion thereof, a suction panel 1030 disposed on the work table 1020 to block the vacuum groove 1021, and having a multiple of through-holes 1031 formed therein, and a vacuum pump 1040 configured to intake air in the vacuum groove 1021.

In this connection, in the vacuum groove 1021, there may be further disposed a chamber 1050 defined into a multiple of vacuum sub-chambers 1051, each sub-chamber having an open top. The vacuum pump 1040 may intake air in each of the vacuum sub-chambers 1051.

The suction panel 1030 may be made of a metal or synthetic resin material. The panel 1030 may cover and block the vacuum groove 1021 formed in the work table 1020 at a top portion thereof. The panel 1030 may be fixed to the work table 1020 using a screw or welding.

In this connection, the suction panel 1030 may be coupled to the table 1020 to form air-tightness between the panel 1030 and the table 1020 while covering a top portion of the chamber 1050. This sealing may be achieved via a wielding or screw coupling. Thus, besides the through-holes 1031 of the panel 1030, there is none of air-leaking portions.

The vacuum pump 1040 may be fluid-coupled to each of the vacuum sub-chambers 1051 via each air intake tube 1041, thus to intake air in each of the vacuum sub-chambers 1051. In this connection, when the vacuum pump 1040 is activated to intake the air in the vacuum sub-chambers 1051, air inflows from externals via the through-holes 1031 into the vacuum sub-chambers 1051. To the contrary, when the countertop workpiece is mounted on the top face of the suction panel 1030 to block the through-hole 1031, air does not inflow from the externals, but the countertop wokrpiece is suctioned to the suction panel. Continuous activation of the vacuum pump 1040 may keep a vacuum state in each of the vacuum sub-chambers.

In this connection, a plastic film, for example, a vinyl film may be added into an interface between the countertop workpiece and the suction panel 1030 to improve an coupling between the suction panel 1030 and to countertop workpiece, leading to more reliable keeping of the vacuum state in each of the vacuum sub-chambers 1051,

During the operation, the countertop workplace made of a marble is suctioned to the suction panel via the vacuum pump 1040 and, at this state, is cut at a top portion thereof using a cutter.

The work table 1020 may be made of a metal or synthetic resin. The cutter may be installed on the work table to cut the countertop workpiece secured to the suction panel 1030.

The chamber 1050 may be made of a metal. As shown in FIG. 13, the chamber 1050 may have the multiple of the vacuum sub-chambers 1051 defined in a top portion thereof in a groove form. The vacuum pump 1040 may be coupled to the air intake tubes 1041 which are respectively fluid-coupled to the vacuum sub-chambers 1051 at a bottom portion of respective sub-chambers. In this connection, each of the air intake tubes 1041 may have a valve 1042 installed thereto configured to be activated in a response to a control signal from a controller 1022 disposed on the work table 1020 to open or close each air intake tube 1041. Specifically, when the countertop workpiece is mounted on the suction panel 1030, the air intake tubes 1041 are closed which are disposed in areas of sealing frames 1032 of the suction panel 1030 not covered by the countertop workpiece.

In an alternative, each air intake tube 1041 may be communicated with each of the vacuum sub-chambers at a side wall of the respective sub-chambers.

At a top portion of the suction panel 1030, each sealing frame may be disposed to correspond to each of the vacuum sub-cambers. The through-holes 1031 may be defined in each of the sealing frames 1032. A top portion of the suction panel 1030 may be defined in a corresponding manner with the vacuum sub-chambers 1051. Thus, a number of the countertop workpieces may be mounted on the suction panel 1030 to cover respectively the sealing frames 1032.

The sealing frames 1032 each may be made, of a synthetic resin with elasticity. The frame may be fusion-bonded or adhered to a body of the suction panel 1030. In this connection, each of the sealing frames 1032 of the suction panel 1030 may be configured to correspond to each of a plurality of the vacuum sub-chambers 1051 of the chamber 1050. In an alternative, one of the plurality of the sealing frames 1032 may correspond to at least two of the plurality of the vacuum sub-chambers 1051. In a further alternative, a single vacuum sub-chamber may correspond to at least two sealing frames 1032. Using the above configuration, air inflows only via the through-holes defined within each of the sealing frame 1032 to suction the countertop workpiece.

Each vacuum sensor 1052 may be installed on each of the vacuum sub-chambers 1051 and may be electrically coupled to the controller 1022. The sensor 1052 may be configured to detect vacuum the sub-chambers 1051 in a non-vacuum state after the activation of the vacuum pump 1040 and to inform the detected sub-chambers to the controller 1022.

In this connection, the controller 1022 is configured to receive the detected sub-chamber 1051 and to dose the valve corresponding to the air intake tube 1041 correspond to the detected sub-chamber 1051.

This embodiment will be described in a brief configuration and operation thereof as follows. The through-holes defined within each of the sealing frames 1032 may communicate with each of the vacuum sub-chambers 1051. The countertop workpiece having a smaller size than the suction panel 1030 is disposed on a top face of the suction panel 1030. Then, upon the activation of the vacuum pump, air inflows via the through-holes within the sealing frames 1032 (hereinafter, non-covered frames) on which the countertop workpiece is not disposed. In this way, during the activation of the vacuum pump 1040, the vacuum sub-chambers 1051 corresponding to the non-covered frames 1032 may not be in a vacuum state. The vacuum sensors 1052 may detect respectively the vacuum sub-chambers 1051 being not in the vacuum state, and, inform the controller 1022 of the detected sub-chambers 1051. In a response to receipt of the detected sub-chambers 1051, the controller 1022 may be configured to close the valves for the air intake tubes 1041 coupled to the detected vacuum sub-chambers 1051 respectively. In this way, the detected vacuum sub-chambers 1051 may not be communicated with the vacuum pump, and, thus, a volume of the chamber to be kept in a vacuum state may be reduced. This may lead to a reduction of the power consumption to suction the workpiece to the suction plate for a subsequent machining thereto,

Due to a machining tolerance or the like of the workpieces, the sealing frames 1032 covered by the workpieces may be not in a vacuum state. In other words, although the sealing frames 1032 are covered by the, workpieces, the vacuum sub-chambers 1051 corresponding to the sealing frames 1032 respectively may not be kept in a vacuum states In this connection, the vacuum sensors 1052 may detect respectively the vacuum sub-chambers 1051 being not in the vacuum state, and, inform the controller 1022 of the detected sub-chambers 1051. In a response to receipt of the detected sub-chambers 1051, the controller 1022 may be configured to close the valves for the air intake tubes 1041 coupled to the detected vacuum sub-chambers 1051 respectively In this way, the detected vacuum sub-chambers 1051 may not be communicated with the vacuum pump, and, thus, a volume of the chamber to be kept in a vacuum state may be reduced. This may lead to a reduction of the power consumption to suction the workpiece to the suction plate for a subsequent machining thereto. In this way, unnecessary air intakes via the pump from the vacuum sub-chambers 1051 involving insufficient sealing between the sealing frames 1032 and the workpieces due to the machining tolerate or the like of the workpieces may be prevented, leading to a suppression of unnecessary power consumptions which may occur otherwise.

In this connection, each space defined by each of the multiple of sealing frames 1032 on the suction panel 1030, the corresponding one of the vacuum sub-chambers 1051, and the countertop workpiece on the sealing frames 1032 may be brought in a vacuum state. That is, a number of the spaces in the vacuum state may correspond to a number of the vacuum sub-chambers 1051. Thus, although some spaces of the number of the spaces may not be brought in a vacuum state due to such as the machining tolerance, etc. remaining numbers of the spaces in the vacuum state may suffice to reliably suction the countertop workpiece to the suction panel 1030.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A method for manufacturing a countertop, the method comprising:
providing a countertop workpiece;
providing a workpiece-mounting device, the device including a pump for air intake; a vacuum plate having a first through-hole defined therein, the first hole being coupled to the pump and acting as an air flow channel during activation of the pump; and a first work plate disposed on the vacuum plate, and having a multiple of second through-holes defined therein;
mounting the countertop workpiece on the first work plate of the workpiece-mounting device;
blocking non-screened holes of the second through-holes using a blocker,
wherein the non-screened holes are not screened by the mounted the countertop workpiece;
activating the pump to intake air via the first through-hole and the second through-hole to allow suction of the countertop workpiece to the workpiece-mounting device; and
cutting a top portion of the countertop workpiece suctioned to the workpiece-mounting device.

2. The method of claim 1, further comprising:
providing the vacuum plate having a multiple of air intake grooves defined in a top portion thereof, and the multiple of the air intake grooves extending in mutually-orthogonal directions; and
activating the pump such that the multiple of the air intake grooves receive air intaked from the first through-hole to allow suction of the first work plate to the vacuum plate.

3. A method for manufacturing a countertop, the method comprising providing a countertop workpiece;
providing a workpiece-mounting device, the device including a pump for air intake; a vacuum plate having a first through-hole defined therein, the first hole being coupled to the pump and acting as an air flow channel during activation of the pump; and a first work plate disposed on the vacuum plate, and having a multiple of second through-holes defined therein; a second work plate disposed on the first work plate, and a hollow mount having one open end and the other end disposed on the second work plate, the mount having a third through-hole defined in a side wall thereof, the third hole being coupled to the pump and acting as an air flow channel during activation of the pump;
mounting the countertop workpiece on the open end of the mount of the workpiece-mounting device;
activating the pump to intake air via the first through-hole and the second through-hole to allow suction of the first and second work plates to the vacuum plate, and to intake air via the third hole to allow suction of the countertop workpiece to the mount; and
drilling the countertop workpiece using a machining apparatus.

4. A countertop machining apparatus for vacuum-suctioning a countertop workpiece thereto and cutting the countertop workpiece using a cutter, the apparatus comprising:
a work table having a vacuum groove defined in a top portion thereof;
a suction panel disposed on the work table to block the vacuum groove, the panel having a multiple of through-holes formed therein;
a vacuum pump configured to intake air in the vacuum groove; and
a vacuum chamber disposed in the vacuum groove, the chamber being defined into a multiple of vacuum sub-chambers, each sub-chamber having an open top portion,
wherein the vacuum pump is configured to intake air in each of the vacuum sub-chambers.

5. The apparatus of claim 4, wherein a plurality of sealing frames are disposed on the suction panel to correspond to the vacuum sub-chambers respectively,
wherein the through-holes are located within each of the sealing frames,
wherein a top portion of the suction panel is divided in a corresponding manner with the vacuum sub-chambers.

6. The apparatus of claim 4, wherein an inner plane area of each of the vacuum sub-chambers is equal to or smaller than an inner plane area of each of the sealing frames.

7. The apparatus of claim 4, wherein each vacuum sensor is disposed in each of the vacuum sub-chambers, wherein each sensor is configured to detect a corresponding sub-chamber in a non-vacuum state and to inform a controller of the detected sub-chamber.

8. The apparatus of claim 7, wherein each air intake tube is fluid-coupled to each sub-chamber, wherein each valve is disposed to each air intake tube, wherein the controller is configured to receive the detected sub-chamber and to dose the valve corresponding to the air intake tube correspond to the detected sub-chamber.

9. A stone-based countertop workpiece, comprising:
a rectangular workpiece body having longitudinal and transverse sides, and
first longitudinal and transverse stripes coupled to the body, the first longitudinal and transverse stripes being substantially right angled relative to the body,
wherein the first longitudinal and transverse stripes are monolithic with the body.

10. The workpiece of claim 9, further comprising second longitudinal and transverse stripes coupled to the first longitudinal and transverse stripes respectively, wherein the second longitudinal and transverse stripes are substantially right angled relative to the first longitudinal and transverse stripes respectively, wherein the first and second longitudinal and transverse stripes are monolithic with the body.

11. The workpiece of claim 10, wherein the first longitudinal and transverse stripes have substantially the same thickness, wherein the second longitudinal and transverse stripes have substantially the same thickness.

12. A countertop manufactured using the method of claim 1.

13. A countertop manufactured using the method of dale

14. A countertop manufactured using the method of claim 3.

15. A stone-based countertop workpiece machined using the apparatus of claim 4.

16. A stone-based countertop workpiece machined using the apparatus of claim 5.

17. A stone-based countertop workpiece machined using the apparatus of claim 6.

18. A stone-based countertop workpiece machined using the apparatus of claim 7.
